(19) United States
(12) Patent Application Publication
(10) Pub. No.: US 2008/0225409 A1
(43) Pub. Date: Sep. 18, 2008

(54) Wide Band Achromatic Visible to Near-Infrared Lens Design

(76) Inventor: Christopher Carl Alexay, Keene, NH (US)

Correspondence Address: Christopher Alexay;Stingray Optics LLC, 310 Marlboro Street, Keene, NH, 03431, US

(21) Appl. No.: 11/684,723

(22) Filed: Mar. 12, 2007

(51) Int. Cl. G02B 13/18; G02B 9/02

(52) U.S. Cl. 359/718; 359/796

(57) ABSTRACT

A lens design comprising a positive lens made of barium fluoride crystal material and a negative lens element made of glass with dispersive properties common to the family of Schott type materials enabling an object to be imaged with superior chromatic aberration correction in the spectral range extending from the visible to the near-infrared region of the electromagnetic spectrum. The achromatic lens design as described has negligible residual and higher order chromatic aberration throughout the visible, the near-infrared or simultaneously both the visible and near-infrared regions of the electromagnetic spectrum.

### BACKGROUND OF THE INVENTION

An objective lens design comprised of at least one element of barium fluoride crystalline material and one element of common optical glass which is capable of producing an image with superior achromatic quality for wavelengths in either the visible, the near-infrared or simultaneously both the visible and near infrared regions of the electromagnetic spectrum.

### BRIEF SUMMARY OF THE INVENTION

An optical design according to the present invention capable of forming an image with superior achromatic quality over the visible (0.4 to 0.7 microns) and the near-infrared (0.7 to 2.5 microns) or simultaneously both the visible and near-infrared (0.4 to 2.5 microns) regions of the electromagnetic spectrum. The lens design of the present invention has negligible residual and higher order chromatic aberrations and is therefore capable of producing imaging for wide spectral bands throughout these regions.

The present invention is comprised of at least one element of barium fluoride crystalline material and at least one element of a significantly less expensive and readily available optical glass such as those produced by Schott Optical Glass, Inc. of Duryea, Pa. The optical design of the present invention can be fabricated by conventional techniques. Furthermore, the present invention utilizes the crystalline material barium fluoride which unlike optical glass has the ability to be formed into aspheric shapes via such optical fabrication methods as single point diamond turning. This advantage allows the invention to produce a high quality image with a lower total element count as compared with designs comprised solely of spherical glass elements. Various versions of the present invention can be produced to support a myriad of imaging applications.

### BRIEF DESCRIPTION OF SEVERAL VIEWS OF THE DRAWING

FIG. 1 depicts the relationship between relative partial dispersion and Abbe V-number for calcium fluoride and barium fluoride as well as a sampling of common optical glasses of the Schott glass variety.

FIG. 2 illustrates the variation in Abbe V-number over the spectral range of the visible through near-infrared spectral range 0.4 to 2.5 microns.

FIG. 3 illustrates an air-spaced lens doublet according to the present invention scaled for an effective focal length of 100 mm at a wavelength λo of 0.9 microns and a relative aperture of f/5 designed to cover a spectral range of wavelengths from 0.45 to 2.5 microns.

FIG. 4 depicts and indicates the variation of RMS (root mean square) spot size (a measure of image blur size and therefore inversely proportional to the ability of the lens to resolve finer detail) with respect to a particular wavelength extending from 0.46 to 2.5 microns throughout the visible and near infrared portion of the electromagnetic spectrum and located at the doublets focal plane.

FIG. 5 shows a side view of my invention in an alternate embodiment. In this figure a three element lens of focal length 100 mm at a wavelength of 0.9 micron and a relative aperture of f/5.

FIG. 6 shows a side view of my invention in an alternate embodiment. In this figure a catadioptric (combination of reflective and refractive elements) objective lens of focal length 500 mm at a wavelength of 0.9 micron and a relative aperture of f/5.

### DESCRIPTION OF THE PREFERRED EMBODIMENT

The current invention provides a much needed lens form which is color corrected for wavelengths of the electromagnetic spectrum including visible and near infrared. The lens is comprised of a unique combination of optical materials namely the crystalline material barium fluoride and an optical glass similar in dispersive properties to that of Schott SF optical glass. The combination of materials enables the lens to image an object in either the visible the near infrared or simultaneously both the visible and the near infrared regions of the electromagnetic spectrum. The lens design of the present invention has practically negligible secondary and higher order spectra throughout the visible and near infrared regions. Furthermore the crystalline material barium fluoride is suitable for diamond turning and therefore capable of aspheric deformation whereby greater control over optical aberrations can be achieved with fewer optical elements.

An alternate method of achromatic correction outlined in Mercado 4,712,886 included the crystalline material Calcium Fluoride (CaF₂) and the infrared transmitting glass IRGN6 to enable greater color correction than a design comprised solely of common optical glass. However although this material allows for greater correction than its all glass counterpart, it has a significantly inferior ability to do so over the near infrared spectral region when compared to that of the material barium fluoride (BaF₂) when the exotic glass IRGN6 is replaced with a less exotic, and less costly common glass. Chromatic aberration associated with a pairing of dissimilar materials is chiefly dependent on the dispersive behavior of the two materials and how that dispersion changes over the spectral band of interest. In the pursuit of wider band chromatic correction, it becomes necessary to consider not only the co-focusing of long and short wavelengths but also consideration of all wavelengths in between. When such intermediate wavelengths deviate from the primary focal point defined by the long and short wavelengths in an achromatic design, the residual error is known as secondary spectrum or residual chromatic aberration. This intermediate departure can become a limiting characteristic of a particular design and as such is a quantity necessary for consideration. One manner of indicating a candidate material pairing's secondary spectrum SS content can be interpreted from the following equation:

$$SS := \frac{F \cdot Δ P}{Δ V}$$

### Where

F=effective focal length for the lens
ΔP=difference in partial dispersion for two candidate materials or (n_{low}−n_{median})/(n_{low}−n_{high}) and
ΔV=difference in Abbe V-number for two candidate materials or (n_{median}−1)/(n_{low}−n_{high})

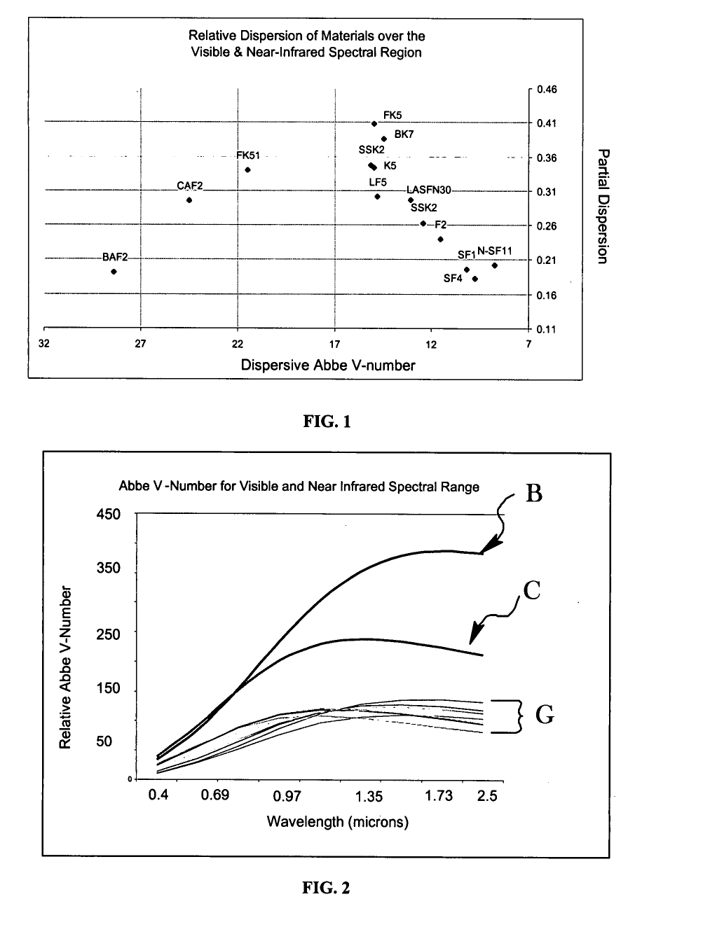

Therefore, for such a pairing to be well controlled over a particular spectral region it is of critical advantage to maximize the difference in Abbe V-numbers while at the same time minimize the difference in the pairings partial dispersion. Additionally, unions with well matched partial dispersions and smaller V-number differences will require stronger individual element powers to achieve the chromatic correction than those with well matched partial dispersion values and larger Abbe V-number differences. Designs with stronger element powers are less desirable since they typically introduce additional aberrations such as spherochromatism and zonal spherical aberration. Such inferior pairings must therefore be designed to work at slower speeds or have many elements to reduce these higher order aberrations. FIG. 1 illustrates the relationship between dispersive Abbe V-number value and the relative partial dispersion for calcium fluoride and barium fluoride as well as a selection of common Schott type optical glasses.

FIG. 1 indicates the advantageous ΔV for a pairing of barium fluoride and an optical glass of similar partial dispersion value when compared to a design of equivalent focal length comprised of calcium fluoride and an optical glass with similar partial dispersion value.

FIG. 2 clearly indicates that although calcium fluoride C is a fair candidate, barium fluoride B greatly exceeds the Abbe V-number advantage as the wavelength extends beyond approximately 0.90 microns with as much as twice the effective chromatic control when paired with a member of the grouping of common optical glasses designated G in FIG. 2. This advantage allows the invention to produce a high quality image with a lower overall element count as compared with designs comprised of all spherical glass elements and or those utilizing the inferior material calcium fluoride. Lower element counts translate to smaller, lighter packages with lower energy transmission loss.

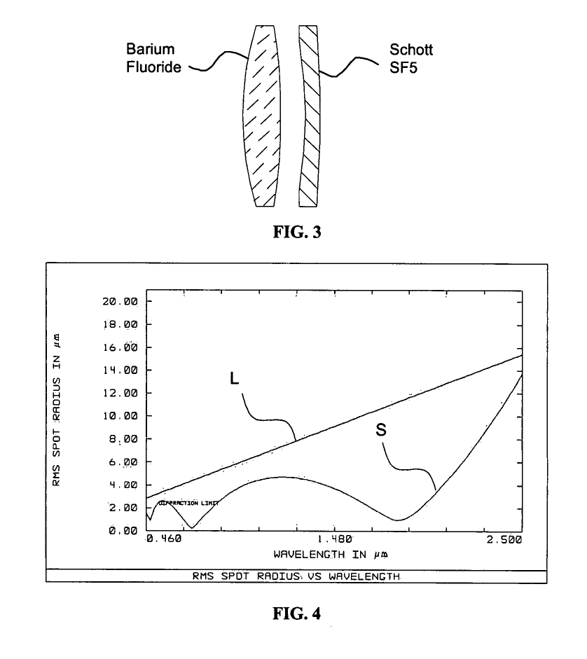

FIG. 3 illustrates an air spaced lens doublet according to the present invention scaled for a 100 mm focal length at λₒ=0.9 microns and a relative aperture of f/5 designed to cover a spectral range of wavelengths from 0.4 to 2.5 microns. The lens design of FIG. 3 comprises a positive lens element made of barium fluoride crystalline material (BaF₂) and a negative lens element made of Schott SF5 glass. The design form of the lens doublet in FIG. 1 is specified in the following table:

| Surface No. | Radius | Thickness | N | V | Material |
|---|---|---|---|---|---|
| 1 | 44.9 mm | 5.0 mm | 1.4693 | 27.462 | BaF |
| 2 | −71.7 mm | 3.3 mm | 1.00 | | |
| 3 | −56.2 mm | 2.0 mm | 1.6851 | 10.388 | SF5 |
| 4 | −153.9 mm | 90.1 mm | 1.00 | | |

Where the lens element surfaces of the doublet are numbered consecutively from left to right in accordance with conventional optical design practice. The “radius” listed for each surface is the radius of curvature of the surface at the relative aperture of f/5. In accordance with convention, the radius of curvature of an optical surface is said to be positive if the center of curvature of the surface lies to the right of the surface, and negative if the center of curvature of the surface lies to the left of the surface. The “thickness” listed for a particular surface is the thickness of the lens element bounded on the left by the indicated surface, where the thickness is measured along the optical axis of the system. N is the refractive index of the lens element bounded on the left by the indicated surface, where the value of the refractive index is given for a wavelength of 0.90 micron. V is the Abbe number for the lens element at the same 0.90 micron base wavelength. The “material” listed for each surface refers to the type of optical material used for making the lens element bounded on the left by the indicated surface. FIG. 4 depicts and indicates the variation of RMS (root mean square) spot radius (a measure of image blur size and therefore inversely proportional to the ability of the lens to resolve finer detail) with respect to a particular wavelength extending from 0.460 to 2.5 microns throughout the visible and near infrared portion of the electromagnetic spectrum and located at the doublet's focal plane. Color correction at the doublet's focal surface is considered diffraction limited and therefore of highest quality for those wavelengths at which RMS spot radius S has a value less than that designated by the diffraction limit indicated by L in the figure.

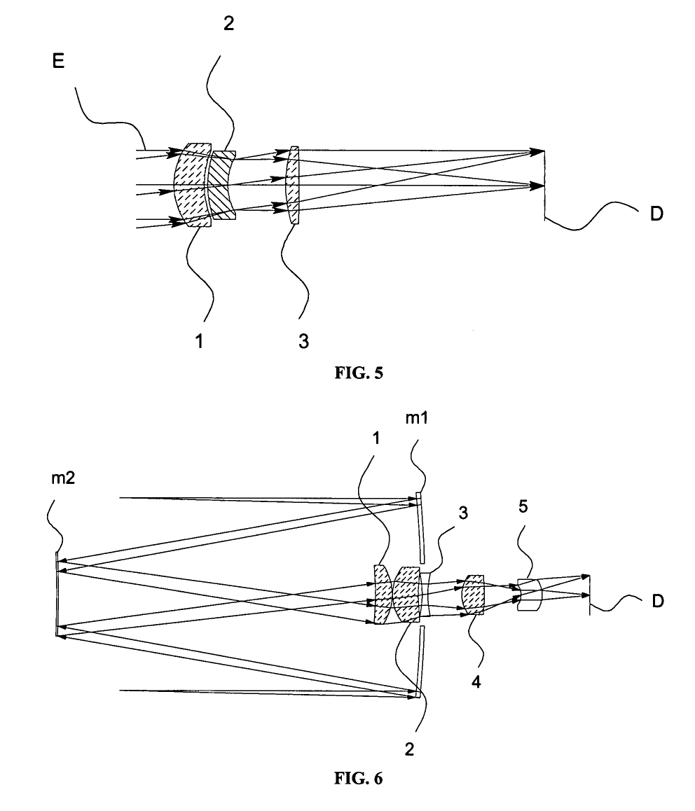

FIG. 5 shows a side view of my invention in an alternate embodiment. In this figure a three element lens of focal length 100 mm at a wavelength of 0.9 micron and a relative aperture of f/5. The lens design in this embodiment of my invention comprises a positive aspheric lens element made of barium fluoride crystal 1 a negative lens element made of Schott SF5 glass 2 and a second positively powered barium fluoride crystal element 3 which is corrected for electromagnetic energy E of wavelengths ranging from 0.45 to 2.5 microns. The design form of my invention is specified in the following table:

| Surface | | | | |
|---|---|---|---|---|
| No. | Radius | Thickness | Material | Aspheric Deformation |
| OBJ | Infinity | Infinity | | |
| 1 | 18.34 mm | 9.50 mm | BAF2 | k = 0.0 |
| | | | | A1 = 0 |
| | | | | A2 = |
| | | | | −5.5166578e−006 |
| | | | | A3 = −8.813245e−009 |
| | | | | A4 = |
| | | | | −7.3072861e−011 |
| 2 | 25.91 mm | 1.00 mm | | |
| 3 | 30.33 mm | 5.90 mm | SF5 | |
| 4 | 16.42 mm | 1.00 mm | | |
| 5 | 36.00 mm | 4.00 mm | BAF2 | |
| 6 | −294.26 mm | 72.32 mm | | |

The “Aspheric Deformation” listed for surface 1 refers to the deformation of the lens element bounded on the left by the indicated surface and described by the aspheric equation:

$$z ( r ) := \frac{c \cdot {r}^{2}}{1 + \sqrt{1 + ( 1 - k ) \cdot ( {c}^{2} ) \cdot {r}^{2}}} + A 1 \cdot {r}^{2} + A 2 \cdot {r}^{4} + A 3 \cdot {r}^{6} + A 4 \cdot {r}^{8} + … + An \cdot {r}^{2 \cdot n} .$$

Where r is the radial height of a point on the surface, c is the surfaces base curvature described as 1/(radius of curvature), k is the surfaces conic constant and A1 . . . An designate the coefficients of deviation from a simple conic surface.

FIG. 6 shows a side view of my invention in an alternate embodiment. In this figure a catadioptric (combination of reflective and refractive elements) objective lens of focal length 500 mm at a wavelength of 0.9 micron and a relative aperture of f/5. The lens design in this embodiment of my invention comprises a set of powered mirrors comprising a front telescope set, m1 and m2 followed by a pair of positive lens elements made of barium fluoride crystal 1 and 2 a negative lens element made of Schott SF6 glass 3 and a third positively powered barium fluoride crystal element with an aspheric deformation 4 followed by a final negative lens element made of Schott SF6 5 which is corrected for electromagnetic energy E of wavelengths ranging from 0.5 to 2.0 microns. The design form of my invention is specified in the following table:

| Surface No. | Radius | Thickness | Material | Aspheric Deformation |
|---|---|---|---|---|
| 1 | Infinity | Infinity | | |
| 2 | −574.0 mm | −193.36 mm | MIRROR | k: 0.5029096 |
| 3 | 803.9 mm | 169.53 mm | MIRROR | k: −96.95659 |
| 4 | 64.0 mm | 9.00 mm | BAF2 | |
| 5 | −38.8 mm | 0.10 mm | | |
| 6 | 28.5 mm | 12.00 mm | BAF2 | |
| 7 | 493.7 mm | 2.10 mm | | |
| 8 | −41.0 mm | 3.00 mm | SF6 | |
| 9 | 97.5 mm | 18.06 mm | | |
| 10 | 19.6 mm | 9.00 mm | BAF2 | k: 0.00 |
| | | | | A1 = 0 |
| | | | | A2 = −2.538579e−005 |
| | | | | A3 = −9.9115535e−009 |
| | | | | A4 = −1.4847526e−010 |
| 11 | −43.7 mm | 19.64 mm | | |
| 12 | −7.8 mm | 11.58 mm | BAF2 | |
| 13 | −13.9 mm | 1.64 mm | | |
| 14 | Infinity | 23.64 mm | | |
| IMA | Infinity | | | |

This invention has been described above in terms and in examples of particular embodiments and applications. However, other embodiments and applications for the invention would be apparent to practitioners in the art of optical design upon examination if the above description and accompanying drawings. Therefore, the foregoing description is to be understood as illustrating the invention, which is defined by the following claims and their equivalents.

What is claimed is:

1. A lens design comprising a first lens element comprised of barium fluoride crystal material and a second lens element comprised of an optical grade glass, said first and second lens elements being made of different refractive materials, each of said refractive materials having a characteristic index of refraction, the indices of refraction of said refractive materials being related to each other so that color correction of said lens design enables an object to be imaged with superior chromatic aberration correction in the spectral range extending from the visible to the near-infrared region of the electromagnetic spectrum.

2. The lens design of claim 1 that provides negligible secondary and higher order chromatic aberration throughout a wavelength band from 0.4 to 2.5 microns.

3. The lens design of claim 1 wherein said first lens element is made of an optical material having a refractive index of approximately 1.474 and an Abbe number of approximately 81.8 at a base wavelength of 0.58756 microns, and wherein said second lens element is made of an optical glass having a refractive index of approximately 1.78 and an Abbe number of approximately 25.6 at said base wavelength.

4. The lens design of claim 1 where said second lens element is made of one member of the Schott SF type glass.

5. The lens design of claim 1 where said second lens element is made of a common optical glass with a partial dispersion proximate in value to that of barium fluoride over the spectral range of 0.4 to 2.5 microns.

6. The lens design of claim 1 wherein said second lens element is made of a material with partial dispersive characteristics equivalent to barium fluoride.

7. The lens design of claim 1 wherein said first element is of a form designated as non-spherical or aspherical to enable greater correction of aberrations including but not limited to; spherical aberration, coma, astigmatism and spherochromatism.

8. An optical imaging system including at least one lens pairing having a first lens element made of barium fluoride crystal and a secondary lens element made of common optical glass with dispersive properties similar to the category of Schott glasses designated as SF type, having respective indices of refraction that are related to each other so that color correction of said lens design over the spectral range designated as visible and near infrared spectral regions is possible.

9. The optical imaging system of claim 8 wherein said secondary optical material is made of a common optical glass with a partial dispersion proximate in value to that of Barium Fluoride over the spectral range of 0.4 to 2.5 microns.

10. The optical imaging system of claim 8 wherein said first element is of a form designated as non-spherical or aspherical to enable greater correction of aberrations including but not limited to; spherical aberration, coma, astigmatism and spherochromatism.
